(19) United States
(12) Patent Application Publication
(10) Pub. No.: US 2022/0181660 A1
(43) Pub. Date: Jun. 9, 2022

(54) A system for controlling fuel flow in proton exchange membrane fuel cells and a fuel ejector

(71) Applicant: Teknologian tutkimuskeskus VTT Oy, Espoo (FI)

(72) Inventors: Kaj Nikiforow, Espoo (FI); Pauli Koski, Espoo (FI); Jari Ihonen, Espoo (FI)

(21) Appl. No.: 17/436,625

(22) PCT Filed: Mar. 5, 2020
(86) PCT No.: PCT/FI2020/050142

§ 371 Date: Sep. 6, 2021

(30) Foreign Application Priority Data
Mar. 5, 2019 (FI) 20195160

(51) Int. Cl. H01M 8/04746; H01M 8/04089; H01M 8/04082; H01M 8/0438

(52) U.S. Cl. CPC H01M 8/04776; H01M 8/04089; H01M 8/04783; H01M 8/04425; H01M 8/04201

(57) ABSTRACT

The present invention concerns a system and a fuel ejector for controlling the fuel flow in proton exchange membrane fuel cells. The ejector comprises a nozzle receiving pressurized fuel from a first inlet into said ejector and including a first tapered section narrowing towards the outlet end of said nozzle in order to provide a flow of fuel, a second inlet for receiving recirculated fuel from a proton exchange membrane fuel cell, a diffuser comprising at least a second tapered section receiving fuel from said nozzle and said second inlet, and an outlet for delivering fuel from said diffuser to the anode system of said proton exchange membrane fuel cell. A shaped elongate rod having a butt end and an opposite pointed is movable lengthwise along its axis to engage with said first tapered section in order to provide a fuel flow control means for the fuel at the outlet of said nozzle. The rod is extending to said at least one second tapered section in order to provide a restriction means for a fuel flow through said diffuser, and wherein said rod is provided at its butt end with a control mechanism arranged to move said rod lengthwise in order to vary the fuel flow path geometry at the outlet of said nozzle and at said diffuser.

### FIELD OF THE INVENTION

The invention relates to proton exchange membrane fuel cells (PEMFC). More specifically, it relates to the control of fuel ejectors in anode gas recirculation systems in such fuel cells.

### BACKGROUND OF THE INVENTION

Ejectors can be employed for anode gas recirculation in proton exchange membrane fuel cells (PEMFCs). In such systems, the hydrogen to be consumed by the fuel cell is initially at high pressure and acts as the ejector primary flow (i.e. the ejector motive flow). The recirculated flow is at low pressure and acts as ejector secondary flow (i.e. the entrained flow). The flows are combined in the ejector from which the outlet flow then enters the fuel feed circuit to the anode(s) of the fuel cell.

Control of the primary flow in such an ejector can be made either by varying the fuel supply pressure, or by varying the flow opening of a primary nozzle throat area in the ejector. The primary nozzle accelerates the primary gas from high pressure and low velocity to low pressure and high velocity. Thus the combination of the nozzle throat diameter and the supply pressure of primary fluid determine the flow rate of primary gas (hydrogen) into the fuel cell anode.

In such ejectors, a mixing section is located downstream of the primary nozzle and the secondary inlet port. Such a mixing section is traditionally a straight tube where the primary and the secondary fluid will mix, before they enter a diffuser section. The diameter of the mixing section affects the maximum fuel flow rate that can pass and the maximum suction pressure that can be achieved with the ejector. For a fuel recirculation system with a given flow resistance, the optimal mixing section diameter depends on the desired primary gas flow and the maximum achievable secondary fuel flow rate, i.e. the fuel recirculation rate.

The optimal design for a fixed geometry ejector for in PEMFC applications is not something that comes straightforwardly, as the ejector must be able to cover a wide range of primary flow rates, and because the optimal sizing of an ejector changes with the flow rate. The two ejector dimensions that most affect the operation are the primary nozzle throat and the mixing section geometry and/or diameter.

The ejectors employed in PEMFC applications can have a fixed geometry, or they may have an adjustable primary nozzle throat and/or they may have adjustable other parts of the ejector.

When using fixed geometry ejectors, the ejector dimensions have to be optimized for some specific operating conditions. It is accepted that the performance may not be optimal at all operating conditions. The primary flow rate must be controlled by adjusting the primary supply pressure, which means that the maximum pressure energy potential is not employed unless operating at maximum flow rate.

The ejector primary flow pressure control can be implemented by using electronically controlled flow restrictors, such as solenoid valves, proportional valves, mass flow controllers, etc., or by using a passively operated pressure reducer.

The ejector primary flow opening can be controlled with a motive needle which position is adjusted with a stepper motor. The approach is similar to a needle valve, where the needle is pushed into a nozzle to restrict the flow and pulled out to allow more flow. A stepper motor does this accurately. Another suggested approach for controlling the nozzle throat geometry is by means of a “propelling nozzle” that changes shape based on the differential pressure across the primary nozzle.

For controlling the mixing section diameter, an approach based on a flexible insert that changes the mixing section diameter based on pressure has been proposed. Another approach that is based on an elastic spring tensioned membrane has also been proposed.

As a fixed geometry ejector cannot be optimized for an entire operating range in PEMFC applications, an ejector which performance may be adapted for current operating conditions, mainly the primary flow rate, will help to avoid compromises on the ejector geometry.

### Object of the Invention

It is an object of the present invention to create a new type of opening control for an ejector primary flow. The present invention differs from prior art in that it enables the simultaneous control of the two most important ejector dimension in PEMFC applications, i.e. the primary nozzle throat opening and the mixing section diameter, and also the diffuser dimensions, by employing a single control mechanism.

### SUMMARY OF THE INVENTION

According to one aspect of the invention a fuel ejector for controlling fuel flow in proton exchange membrane fuel cells is provided. The inventive ejector comprises
a nozzle receiving pressurized fuel from a first inlet into the ejector and including a first tapered section narrowing towards the outlet end of the nozzle in order to provide a flow of fuel,
a second inlet for receiving recirculated fuel from a proton exchange membrane fuel cell,
a diffuser comprising at least a second tapered section receiving fuel from the nozzle and the second inlet,
an outlet for delivering fuel from the diffuser to the anode system of the proton exchange membrane fuel cell,
a shaped elongate rod having a butt end and an opposite pointed, the rod being movable lengthwise along its axis to engage with the first tapered section in order to provide a fuel flow control means for the fuel at the outlet of the nozzle.

The rod is extending to the at least one second tapered section in order to provide a restriction means for a fuel flow through the diffuser. The rod is provided at its butt end with a control mechanism arranged to move the rod lengthwise in order to vary the fuel flow path geometry at the outlet of the nozzle and at the diffuser.

In the context of the present invention, the mixing section is a controlled part of the diffuser. A diffuser section may have many shapes, which are generally static, but the flow in a mixing section immediately preceding the diffuser section may be altered.

In some embodiments, the rod may slide in a hollow cavity of the nozzle to engage with the first tapered section, in order to provide a first adjustable restriction means for the fuel flowing out of the nozzle. The pointed end then engages with the second tapered section in order to provide a second adjustable restriction means in the diffuser.

In some embodiments, the rod may slide inside the diffuser to engage with the second tapered section of the diffuser in order to provide a second adjustable restriction means in the diffuser. The pointed end then engages with the first tapered section in order to provide a first adjustable restriction means for the fuel flowing out of the nozzle.

In some embodiments, the elongate rod has at a butt end a pressure sensing plate exerting a bias force on the rod caused by a pressure sensing means at the ejector outlet, and a passive force element which compensates for changes in the pressure sensed at the ejector outlet by counteracting the bias force in order to control the pressure at the ejector outlet. The passive force element may comprise a spring or a pilot pressure, such as the cathode air inlet pressure of the proton exchange membrane fuel cell.

In some embodiments, the elongate rod may have at a butt end a stepper motor, a control unit for the stepper motor and a pressure transducer that senses the fuel gas pressure at the outlet of the ejector and feeds the control system with pressure information. The position of the rod is then adjusted with the stepper motor to control the pressure at the ejector outlet.

The butt end of the rod and the control mechanism may in some embodiments be located at the fuel inlet end of the ejector, or at the outlet end of the ejector.

According to a second aspect of the invention, a system for controlling fuel flow in proton exchange membrane fuel cells is provided. The inventive system comprises
a fuel ejector having an outlet for delivering fuel to the anode system of a proton exchange membrane fuel cell;
a proton exchange membrane fuel cell connected to the ejector;
a control mechanism arranged to vary the fuel flow path geometry in the fuel ejector.

The fuel ejector in the inventive system comprises
a nozzle receiving pressurized fuel from a first inlet into the ejector and including a first tapered section narrowing towards the outlet end of the nozzle in order to provide a flow of fuel,
a second inlet for receiving recirculated fuel from a proton exchange membrane fuel cell,
a diffuser comprising at least a second tapered section receiving fuel from the nozzle and the second inlet,
a shaped elongate rod having a butt end and an opposite pointed, the rod being movable lengthwise along its axis to engage with the first tapered section in order to provide a fuel flow control means for the fuel at the outlet of the nozzle.

The rod is extending to the second tapered section in order to provide a restriction means for a fuel flow through the diffuser. The rod is provided at its butt end with the control mechanism arranged to move the rod lengthwise in order to vary the fuel flow path geometry at the outlet of the nozzle and at the diffuser.

Further embodiments of the inventive system are characterized by what is stated in the appended claims.

The inventive approach to a solution to the problem is that the major ejector dimensions, which in PEMFC applications are the primary nozzle throat opening and the mixing section diameter, are adjusted with a single mechanism. This results in a less expensive and simpler ejector design.

The present invention enables the simultaneous control of the two most important ejector dimensions in PEMFC applications, the primary nozzle throat opening and the mixing section by employing a single control mechanism.

### BRIEF DESCRIPTION OF THE DRAWINGS

FIG. 1 shows a system for controlling a primary fuel flow in PEMFC cells according to at least some embodiments of the invention;

FIG. 2 shows an ejector according to prior art;

FIG. 3A-3C shows some embodiments of the invention;

FIG. 4A-4C shows further embodiments of the invention.

FIG. 5 shows the influence of the diameter ratio Dₘ/Dₙₜ=δ on the entrainment ratio χ at different currents I of the fuel cell.

### DETAILED DESCRIPTION OF EMBODIMENTS

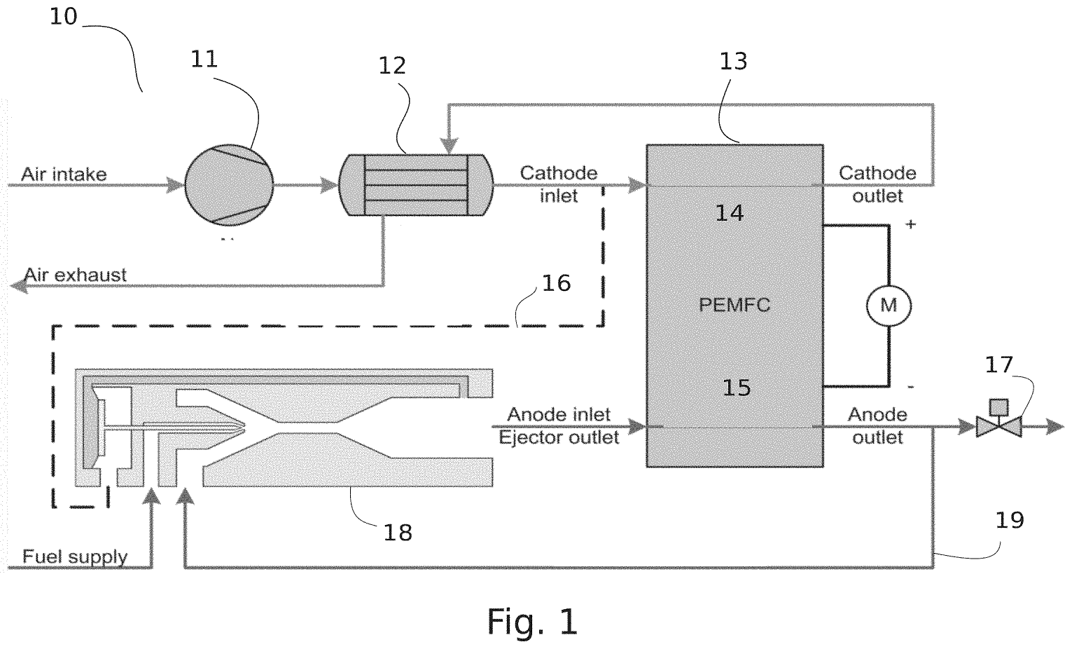

Reference is made to FIG. 1, which provides an overview of a system 10 for controlling a primary fuel flow in a proton exchange membrane fuel cell (PEMFC) 13 connected to a load M. On the cathode side, an air compressor 11 is coupled to an air intake and feeds pressurized air into membrane humidifier 12. Humidified air is fed through the cathode compartment C of the fuel cell 13 via a cathode inlet, and returns from the cathode outlet to the humidifier 12, as shown. On the anode side, a high pressure fuel feed 14 from a fuel supply is fed to a fuel ejector 18. The ejector outlet/anode inlet 15 delivers fuel (hydrogen) to the anode compartment A of the PEMFC fuel cell 13, driving the load M. From the anode outlet, a portion of fluid mixture (consisting mainly of hydrogen, nitrogen and water) is discharged from the system through a purge valve 17, while the rest is recirculated back to a second inlet of the fuel ejector 18 via a low pressure secondary fuel feed line 19. Discharging a portion of the anode outlet fluid prevents fuel impurity build-up in the recirculation line and hence ensures stable operation and high performance of the PEMFC.

The inlet pressure at the anode compartment A may be 2 bar gauge or less. The pressure loss across the anode may be tens or a few hundred mbar, for example. Thus the pressure in the recirculation line 19 may be only slightly less than the anode fuel inlet pressure.

According to the invention, a passive force element is provided by the pilot pressure taken via line 16 from the cathode air inlet of the proton exchange membrane fuel cell. This ensures the anode input pressure follows the cathode input pressure, as the pilot pressure provides a counter-force to the needle bias of the ejector, as explained below.

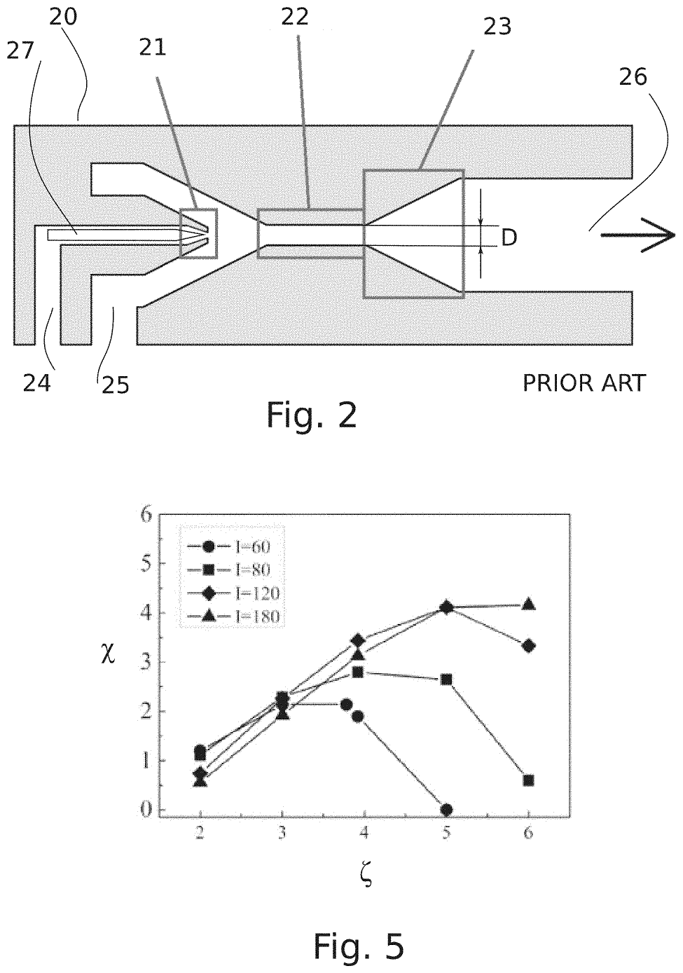

In FIG. 2 an ejector 20 according to prior art is shown. A primary nozzle 21 accelerates the primary gas from high pressure—low velocity inlet port 24 to a low pressure—high velocity downstream of the primary nozzle 21. Thus, the combination of the primary nozzle throat diameter and the supply pressure at the primary gas inlet port 24 determine the flow rate of fresh primary gas (hydrogen) into the fuel cell anode. A mixing section 22 is located downstream of the primary nozzle 21 and a secondary low pressure gas inlet port 25. A motive needle 27 having a pointed end may be controllably sliding in the nozzle cavity, in order to be able to adjust the throat diameter of the nozzle 21.

The mixing section 22 is a straight inlet tube of the diffuser, where the primary and the secondary gases will mix before they enter the actual diffuser section 23. The diameter D of the mixing section determines the maximum fuel flow rate that can pass and the maximum suction pressure that can be achieved with the ejector 20. For a system with a given flow resistance, the optimal mixing section diameter D depends on the desired primary gas flow and the maximum achievable secondary gas flow rate at 25, i.e. the fuel recirculation rate.

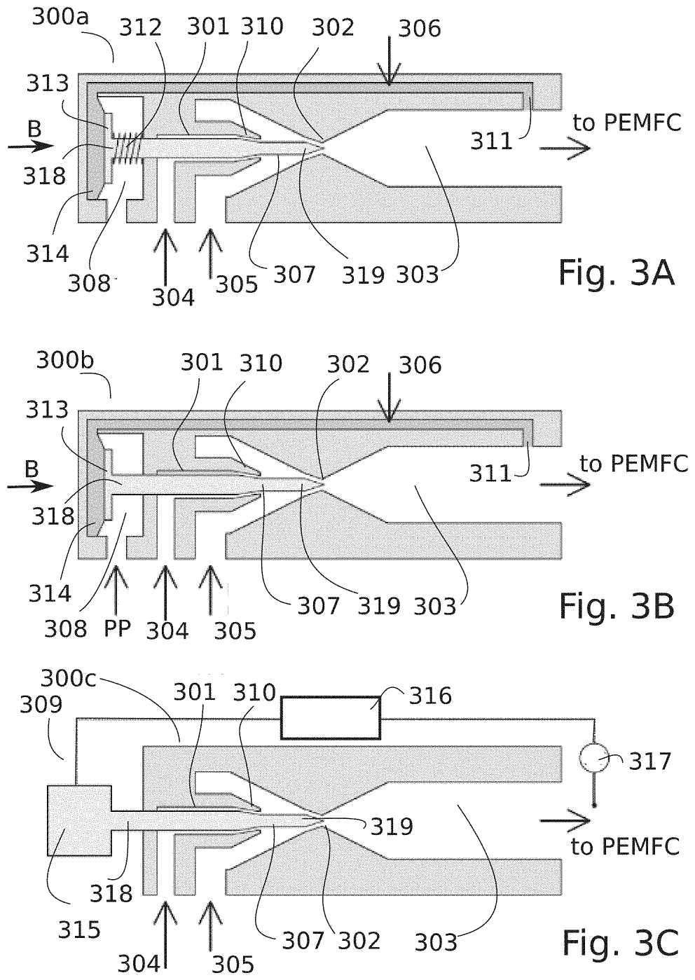

Controlling the primary nozzle flow opening in an ejector is usually done with a stepper motor (not shown). The stepper motor together with control electronics and a pressure transducer adjusts the position of the motive needle 27 to provide the correct amount of fuel to the anode. Referring now to FIGS. 3A-3C, some embodiments of an ejector 300a-300c according to the present invention are shown. All ejectors 300a-300c have a similar structure including a primary nozzle 301, a mixing section 302 and a diffuser section 303.

The ejector comprises an elongate nozzle 301 receiving pressurized fuel from a first inlet 304 into the ejector. In the embodiments of FIGS. 3A-3C, a pressure-sensing rod 307 is used that has a butt end 318 and a pointed end 319 and which is sliding in the elongate nozzle cavity 301. The position of the rod is controlled at the fuel input end to the left of the ejector 300a-300c. Its pointed end 319 is pointing in the direction of a mixing region 302, a diffuser 303 and the outlet “to PEMFC” of the ejector 300a.

A second inlet 305 is provided for receiving recirculated fuel from a fuel recirculation line in the proton exchange membrane fuel cell (see line 19 in FIG. 1). The primary gas delivered at high velocity from nozzle 301 is mixed with the secondary gas from inlet 305 when the two gases come in contact in mixing section 302. The gas mixture decelerates in diffuser 303, whereupon the pressure increases at the outlet to a higher level than at inlet 305. The gas mixture is delivered from the ejector outlet (arrow “to PEMFC”) to the anode compartment of a proton exchange membrane fuel cell (see FIG. 1).

The capacity of the mixing section 302, i.e. the gas flow rate and the pressure, can be varied with the shaped rod 307 that is movable in its axial direction. With the same rod 307, it is according to the present invention possible also to engage the rod 307 with the primary nozzle throat 310 section, whereby the throat section 310 of the primary nozzle 301 may be varied. By carefully designing the shape of the rod, both the throat 310 of primary nozzle 301 and the capacity of the mixing section 302 can be varied simultaneously throughout the ejector operating range, while maintaining optimized dimensions of the primary nozzle 301 and the mixing section 302.

While the various dimensions of the shapes of the rod, the nozzle and the mixing section will produce a large scatter of properties, the one skilled in the art may through tests and by measuring ejector performance parameters, such as the entrainment ratio, be able to design appropriate ejectors for the various embodiments of the present invention. Entrainment ratio may be defined as a ratio between the mass flow in the secondary inlet (mₛ) to the mass flow in the primary inlet (mₚ), given by χ=mₛ/mₚ.

The mixing section diameter (Dₘ) to the nozzle throat diameter (Dₙₜ) ratio is an important factor in the performance of an ejector. The influence of this diameter ratio Dₘ/Dₙₜ=ζ on the entrainment ratio χ at different currents I of the fuel cell is demonstrated in FIG. 5 [1]. The current I correlates directly with the fuel feed rate.

It can be seen that at a PEMFC load current of I=180 A, a maximum entrainment ratio (i.e. maximum recirculation rate, which is usually targeted at) may be obtained with a diameter ratio of ζ=6. However, at I=60 A, a maximum entrainment ratio may be obtained with a diameter ratio of ζ=3. This example assumes constant nozzle throat diameter but it applies equally to the situation when the nozzle throat diameter is varied with the exception that ζ represents the ratio of mixing section diameter to the nozzle throat diameter at maximum primary gas flow rate. The conclusion is that the optimal mixing section diameter might may vary notably depending on the instantaneous load of the PEMFC.

As stated above, by designing the shape of the rod, the primary nozzle and the mixing section accordingly, optimum performance of the ejector may be maintained throughout is operation range.

In the embodiments of FIG. 3A-3C, the rod position is adjusted from the butt end 318 of the rod 307 located at the ejector inlet end. Exemplary mechanisms for controlling the rod and needle position are shown and described below.

In FIG. 3A is shown a control mechanism based on an ejector outlet pressure sensed via a sense line 306. The pressure is sensed from an opening 311 in the ejector outlet of the pressure sensing line 306. The bias force B sensed at ejector outlet “to PEMFC” presses the rod 307 from a pressure sensing plate 313 to the right in FIG. 3A, via a diaphragm 314 or with a piston (not shown) functioning in a similar manner. This makes the flow opening at nozzle 301 smaller as the ejector outlet pressure increases. The ejector primary flow then decreases and the ejector outlet pressure decreases.

The bias force B is counteracted in this exemplary embodiment by a passive spring element 312, which spring force compensates and works towards making the flow area larger at nozzle throat section 301. When the ejector outlet pressure decreases, the spring 312 acts on the pressure sensing plate 313 to push the rod 307 to the left in FIG. 3A. This makes the flow opening at 310 larger, which results in higher primary flow rate and an increased ejector outlet pressure. The primary flow rate may thus be adjusted by axially moving the rod 307 to change the ejector 300a nozzle geometry. Simultaneously, as the rod 307 moves leftwards, the mixing section 302 geometry will also change, typically to increase the flow, but it can also be designed to decrease the flow. The design required to achieve maximum performance is application specific.

The shape of the rod 307 is optimized with the ejector inner dimensions so that the ejector reaches maximum performance at all primary gas flow rates, as determined by the nozzle 301 throat 310 opening. The target is to approaches an equilibrium state between the position of the rod 307 and the ejector outlet pressure. By choosing the spring 312 and the pressure plate 313 area carefully, the arrangement can maintain a roughly constant ejector outlet pressure with varying flow rates. The chamber 308 may in this embodiment be at ambient pressure.

In FIG. 3B is shown a control mechanism based on an ejector outlet pressure sensed via a sense line 306, similar to the embodiment shown in FIG. 3A, but with a pilot pressure controlled mechanism. According to this exemplary embodiment, the pressure is sensed from the opening 311 in the ejector outlet 303 of the pressure sensing line 306. The force sensed at ejector outlet “to PEMFC” presses the rod 307 with a bias force B to the right in FIG. 3B, by means of the pressure plate 313 and diaphragm 314. This makes the flow opening at nozzle 301 smaller as the ejector outlet pressure increases. The ejector primary flow then decreases and the ejector outlet pressure decreases.

In the embodiment of FIG. 3B, the bias force B is counteracted by a pilot pressure PP entering the chamber 308 formed around the pressure plate 313 and the diaphragm 314. The pilot pressure provides a counter-force on the opposite side of the pressure plate 313 to the bias force B, and compensates for variations in the pressure sensed at the ejector outlet.

The pilot pressure PP works towards making the flow area larger at the throat 310 of the nozzle 301, so that when the ejector outlet pressure decreases, the pilot pressure PP pushes the rod 307 to the left in FIG. 3B and backwards in the nozzle 301, thus making the flow opening larger. This will result in a higher primary flow rate and an increased ejector outlet pressure. When the rod 307 moves left, the mixing section 302 geometry will change accordingly, typically to increase the flow. Again, the specific design required to achieve maximum performance depends on the application.

The position of the rod 307 and the ejector outlet pressure approaches an equilibrium state. The pilot pressure PP may be the same as the cathode air supply pressure to the proton exchange membrane fuel cell, which brings the benefit of that the ejector outlet pressure then follows the air supply pressure, which is usually a preferred condition in a PEMFC fuel cell. The pilot pressure may alternatively be any desired or available reference pressure, which correlates with the performance or durability of the fuel cell.

As the cathode pressure is determined by the amount of air to be fed to the fuel cell, i.e. the current power level of the cell, the inventive arrangement ensures that only a small pressure difference occur at the proton exchange membrane in all situations, which ensures that the fuel cell membrane will not be damaged by excess pressure differences.

In FIG. 3C is shown how the nozzle throat 310 and the mixing section geometry can be varied a stepper motor, where the position of the rod 307 is adjusted with a stepper motor system 309. The system comprises a stepper motor 315 manipulating the axial position of the rod 307 from the butt end 318 of the rod, a control unit 316 and a pressure transducer 317 which senses the fuel gas pressure at the outlet of the ejector 300c. In this embodiment, the stepper motor 315 keeps the rod 307 in the optimal position as determined by the pressure measured with the transducer and a control algorithm running in control unit 316. Other input signals (e.g. cathode inlet air pressure and PEMFC load current) to the control unit 316 (not shown) can also be employed for the control of rod position if seen useful. As in the embodiments shown in FIGS. 3A and 3B, the position of the needle rod 307 and the ejector outlet pressure can be set to an equilibrium state where, for example, a roughly constant ejector outlet pressure can be maintained with varying flow rates, or the pressure at the ejector outlet 303 is roughly the same as the air pressure at the cathode inlet of the fuel cell 13 (FIG. 1).

The control unit 316 may comprise, for example, a single- or multi-core processor wherein a single-core processor comprises one processing core and a multi-core processor comprises more than one processing core. The control unit 316 may in itself comprise an industrial or general-purpose computer having a processor or processing core that runs the analysis software required for pressure measurement and stepper motor control. The control unit 316 may be a micro controller or a programmable logic controller (PLC). In the context of the present disclosure, the exact computer configuration is not essential to carry out the invention and any circuitry and/or wireless communication system may be used for transferring data from the pressure transducer 317 to the control unit and/or between the control unit and the stepper motor 315.

A processing core may comprise, for example, a Cortex-A8 processing core manufactured by ARM Holdings, a Steamroller processing core produced by Advanced Micro Devices Corporation, or at least one Qualcomm Snapdragon and/or Intel Atom processor. The control unit may comprise at least one application-specific integrated circuit, ASIC, or at least one field-programmable gate array, FPGA.

A processor may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.

As a further example, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular wireless device, or other computing or network device.

Further components of the control unit may be a touchscreen user interface, one or several communication units and the internet.

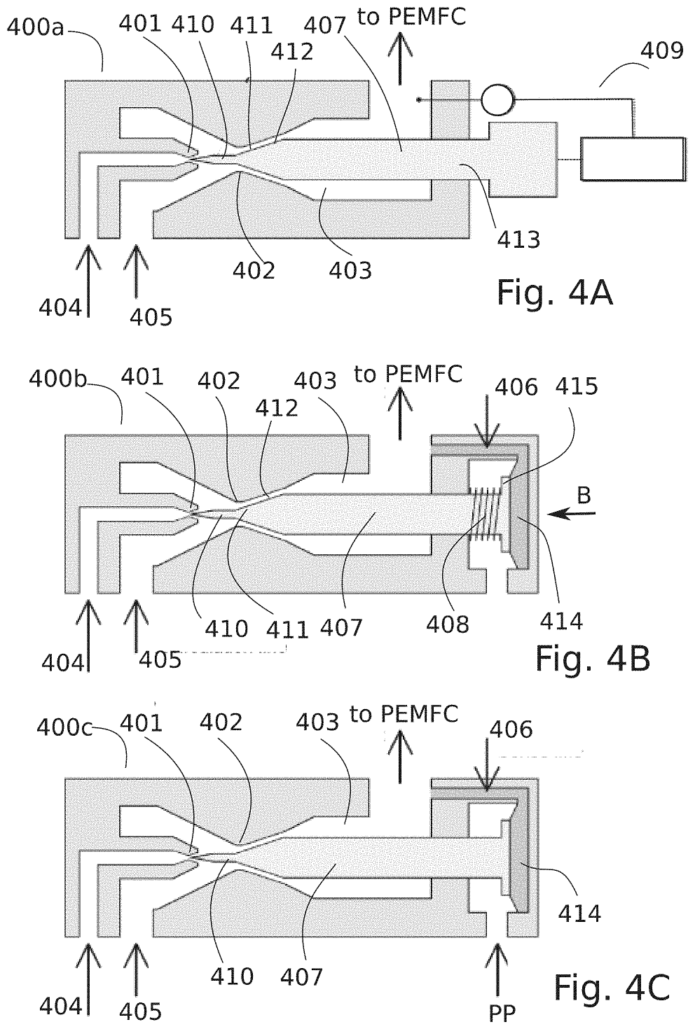

In FIGS. 4A-4C is shown similar embodiments to those presented in FIGS. 3A-3C, but with a rod position control mechanism located at the output end to the right of the ejector 400a-400c. Again, all ejectors 400a-400c have a similar structure including a primary nozzle 401, a mixing section 402 and a diffuser section 403. The ejector is receiving pressurized fuel from a first inlet 404, and recirculated fuel from a fuel recirculation line from a second inlet 405, as explained above.

The geometry of the ejector's nozzle throat portion 401, which is receiving pressurized fuel from a first inlet 404, is controlled by a pointed end 410 of a rod 407. A conical portion 411 of the rod 407 is controlling the geometry of the mixing region 402. An extension 412 of the conical portion 411, which may or may not be shaped differently than 411, extends into the diffuser section 403, which flow geometry thus also may be varied with the same rod 407.

In FIG. 4A, the position of the rod 407 is controlled by a stepper motor system 409 operating at the butt end 413 of the rod 407 in a similar manner as described in connection with FIG. 3C. In FIG. 4B, the position of the rod 407 is controlled by a pressure sensing line 406 sensing the pressure at the output of the ejector 400b and providing a bias force B, a diaphragm 414, a pressure plate 415 and a passive spring element 408 counteracting the bias force B, in a manner corresponding to the mechanism shown in FIG. 3A. Finally, the embodiment shown in FIG. 4C corresponds to the embodiment shown in FIG. 3B, with a pilot pressure PP acting as a counterforce to the bias force B caused by the pressure sensing line 406 and the diaphragm 414.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### CITED REFERENCES

[1] E. Hosseinzadeh, M. Rokni, M. Jabbari, H. Mortensen, Numerical analysis of transport phenomena for designing of ejector in PEM forklift system, Int. J. Hydrogen Energy. 39 (2014) 6664-6674. doi:http://dx.doi.org/10.1016/j.ijhydene.2014.02.061.

### INDUSTRIAL APPLICABILITY

At least some embodiments of the present invention find industrial application in systems for controlling primary fuel flow in proton exchange membrane fuel cells.

1. A fuel ejector for controlling fuel flow in proton exchange membrane fuel cells, wherein the ejector comprises:
a nozzle receiving pressurized fuel from a first inlet into said ejector and including a first tapered section narrowing towards the outlet end of said nozzle in order to provide a flow of fuel,
a second inlet for receiving recirculated fuel from a proton exchange membrane fuel cell,
a diffuser comprising at least a second tapered section receiving fuel from said nozzle and said second inlet,
an outlet for delivering fuel from said diffuser to the anode system of said proton exchange membrane fuel cell, and
a shaped elongate rod having a butt end and an opposite pointed, said rod being movable lengthwise along its axis to engage with said first tapered section in order to provide a fuel flow control means for the fuel at the outlet of said nozzle,
wherein said rod is extending to said at least one second tapered section in order to provide a restriction means for a fuel flow through said diffuser, and wherein said rod is provided at its butt end with a control mechanism arranged to move said rod lengthwise in order to vary the fuel flow path geometry at the outlet of said nozzle and at said diffuser.

2. The fuel injector according to claim 1, wherein said rod is sliding in a hollow cavity of said nozzle to engage with said first tapered section in order to provide a first adjustable restriction means for the fuel flowing out of said nozzle, and wherein said pointed end engages with said second tapered section in order to provide a second adjustable restriction means in the diffuser.

3. A The fuel injector according to claim 1, wherein said rod is sliding inside said diffuser to engage with said second tapered section of said diffuser in order to provide a second adjustable restriction means in the diffuser, and wherein said pointed end engages with said first tapered section in order to provide a first adjustable restriction means for the fuel flowing out of said nozzle.

4. The fuel injector according to claim 1, wherein said elongate rod has at said butt end a pressure sensing plate exerting a bias force on the rod caused by a pressure sensing means at said ejector outlet, and a passive force element which compensates for changes in the pressure sensed at said ejector outlet by counteracting said bias force in order to control the pressure at said ejector outlet.

5. The fuel ejector according to claim 4, wherein the passive force element comprises a spring.

6. The fuel ejector according to claim 4, wherein the passive force element comprises a pilot pressure, such as the cathode air inlet pressure of said proton exchange membrane fuel cell.

7. The fuel ejector according to claim 1, wherein said elongate rod has at said butt end a stepper motor, a control unit for said stepper motor and a pressure transducer that senses the fuel gas pressure at the outlet of said ejector and feeds said control system with pressure information, and wherein the position of said rod is adjusted with said stepper motor to control the pressure at said ejector outlet.

8. The fuel ejector according to claim 1, wherein said butt end of said rod and said control mechanism is located at the fuel inlet end of said ejector.

9. The fuel ejector according to claim 1, wherein said butt end of said rod and said control mechanism is located at the outlet end of said ejector.

10. A system for controlling fuel flow in proton exchange membrane fuel cells, comprising:
a fuel ejector having an outlet for delivering fuel to the anode system of a proton exchange membrane fuel cell;
a proton exchange membrane fuel cell connected to said ejector; and
a control mechanism arranged to vary the fuel flow path geometry in said fuel ejector;
wherein said fuel ejector comprises:
a nozzle receiving pressurized fuel from a first inlet into said ejector and including a first tapered section narrowing towards the outlet end of said nozzle in order to provide a flow of fuel,
a second inlet for receiving recirculated fuel from a proton exchange membrane fuel cell,
a diffuser comprising at least a second tapered section receiving fuel from said nozzle and said second inlet, and
a shaped elongate rod having a butt end and an opposite pointed, said rod being movable lengthwise along its axis to engage with said first tapered section in order to provide a fuel flow control means for the fuel at the outlet of said nozzle,
wherein said rod is extending to said at least one second tapered section in order to provide a restriction means for a fuel flow through said diffuser, and wherein said rod is provided at its butt end with said control mechanism arranged to move said rod lengthwise in order to vary the fuel flow path geometry at the outlet of said nozzle and at said diffuser.

11. The system according to claim 10, wherein said control mechanism comprises a pressure sensing plate located at said butt end of said elongate rod that exerts a bias force on the rod caused by a pressure sensing means at said ejector outlet, and a passive force element which compensates for changes in the pressure sensed at said ejector outlet by counteracting said bias force in order to control the pressure at said ejector outlet.

12. The system according to claim 11, wherein the passive force element comprises a spring.

13. The system according to claim 11, wherein the passive force element comprises a pilot pressure, such as the cathode air inlet pressure of said proton exchange membrane fuel cell.

14. The system according to claim 10, wherein said control mechanism comprises at the butt end of said elongate rod a stepper motor, a control unit for said stepper motor and a pressure transducer that senses the fuel gas pressure at the outlet of said ejector and feeds said control system with pressure information, and wherein the position of said rod is adjusted with said stepper motor to control the pressure at said ejector outlet.

15. The system according claim 10, wherein said butt end of said rod and said control mechanism is located at the fuel inlet end of said ejector.

16. The system according to claim 10, wherein said butt end of said rod and said control mechanism is located at the outlet end of said ejector.
